(19) United States
(12) Patent Application Publication
(10) Pub. No.: US 2007/0139132 A1
(43) Pub. Date: Jun. 21, 2007

(54) YIG filter tuning system

(76) Inventors: Joseph M. Gorin, Santa Rosa, CA (US); Bruce A. Erickson, Santa Rosa, CA (US); Darrin Dennis Rath, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/305,740

(22) Filed: Dec. 16, 2005

(51) Int. Cl. H04B 3/04

(52) U.S. Cl. 333/17.1

(57) ABSTRACT

A Ytrium Iron Garnett (YIG) filter tuning system includes a YIG filter having a filter passband and associated filter bandwidth, a noise source selectively coupled to an input of the YIG filter, and a receiver coupled to an output of the YIG filter, the receiver having a measurement passband with an associated measurement bandwidth that is less than the filter bandwidth. The receiver acquires a series of measurements at the output of the YIG filter within the measurement passband and within the filter passband when the noise source is coupled to the input of the YIG filter.

### BACKGROUND OF THE INVENTION

Ytrium Iron Garnett (YIG) filters are tunable bandpass filters that are included in a variety of test and measurement systems. For example, YIG filters are included in microwave signal sources to filter generated signals to provide the sources with spectrally pure output signals. YIG filters are also included in the front-end sections of microwave spectrum analyzers as a pre-selector for applied input signals. YIG filters have the advantages of high frequency selectivity and broad frequency tuning ranges. However, YIG filters also have the disadvantages of frequency drift, tuning hysteresis and other anomalies that make it difficult to accurately set and maintain the center frequency of the filter passband of the YIG filter at a frequency of interest.

When the center frequency of the YIG filter in a microwave signal source is not accurately set or maintained, the maximum power of the output signal provided by the source can be reduced, and the spectral purity of the output signal can be compromised. When the center frequency of a YIG filter in a microwave spectrum analyzer is not accurately set or maintained, amplitude errors in the response of the analyzer can result.

Presently available test and measurement systems typically include filter alignment algorithms that either manually, or automatically correct for tuning errors in setting or maintaining the center frequency of the YIG filters. A factory calibration of the YIG filter typically provides a preliminary or coarse tuning, whereas the filter alignment algorithms provide precise alignment of the center frequency of the YIG filter with a frequency of interest.

Conventional filter alignment algorithms apply CW (continuous-wave) signals to the YIG filter at one or more frequencies associated with the frequency of interest to assess the frequency tuning of the YIG filter and to adjust the frequency tuning of the YIG filter relative to the preliminary tuning provided by the factory calibration. The filter alignment algorithm is invoked periodically, or based on the operating states of the test and measurement system to accommodate for drifts in the center frequency of the YIG filter that are thermally induced, induced by changes in operating states, or induced by drifts in drive circuitry used to tune the center frequency of the YIG filter.

The CW signals applied within the filter alignment algorithm can result in unwanted output signals in a microwave signal source. In a microwave spectrum analyzer, the CW signals relied upon within the filter alignment algorithm are typically not available within the analyzer. To provide the CW signals to the microwave spectrum analyzer from an external signal source can be expensive, and inconvenient since the external signal source must typically be coupled to the microwave spectrum analyzer while the filter alignment algorithm is invoked and de-coupled from the microwave spectrum analyzer after alignment of the center frequency of the YIG filter.

Accordingly, there is a need for a YIG filter tuning system suitable for aligning the center frequency of a YIG filter with a frequency of interest, that does not rely on applying a CW signal to the YIG filter.

### BRIEF DESCRIPTION OF THE DRAWINGS

FIG. 1 shows a YIG filter tuning system according to embodiments of the present invention.

FIG. 2 shows an example of a conventional spectrum analyzer suitable for including the YIG filter tuning system according to the embodiments of the present invention.

FIG. 3 shows an example of a filter passband of a YIG filter included in the YIG filter tuning system according to embodiments of the present invention.

FIG. 4 shows a detailed view of the YIG filter tuning system according to embodiments of the present invention.

FIGS. 5A-5B show series of measurements acquired using the YIG filter tuning system according to alternative embodiments of the present invention.

FIG. 6 shows a flow diagram of one example of processing for the acquired series of measurements by YIG filter tuning system according to embodiments of the present invention.

FIGS. 7A-7D show a series of graphs associated with the flow diagram of FIG. 6.

### DETAILED DESCRIPTION

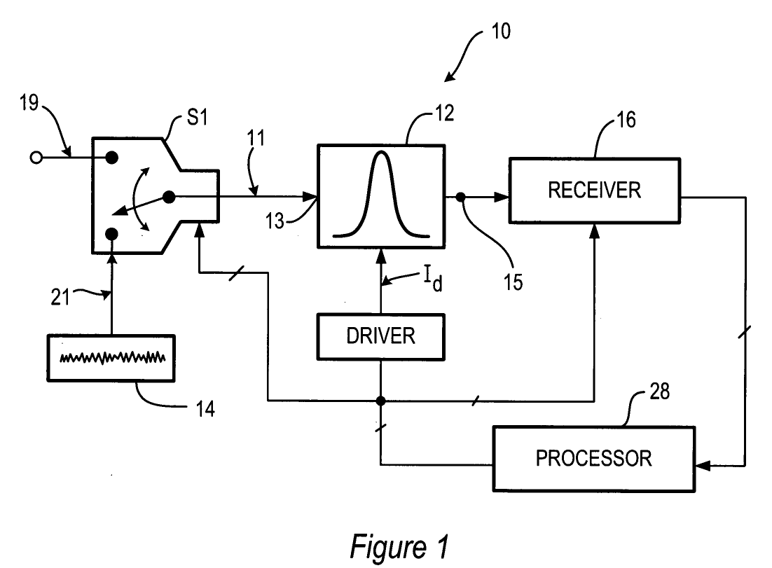

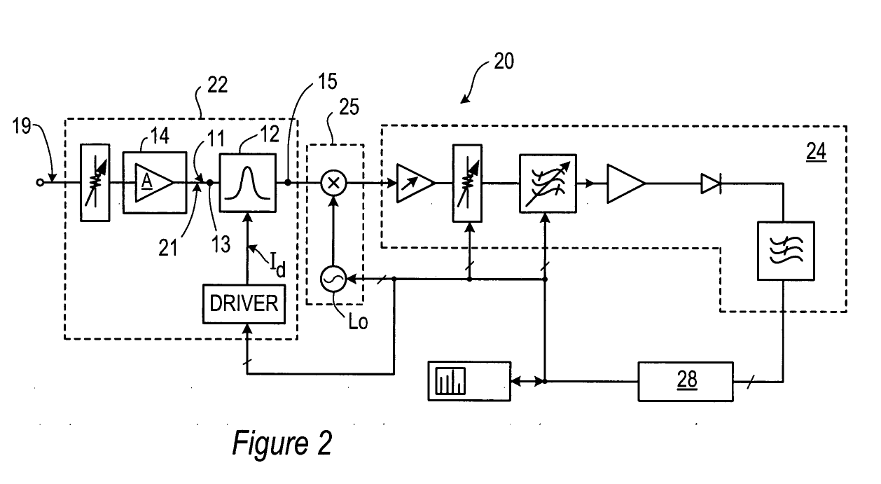

FIG. 1 shows a YIG filter tuning system 10 according to embodiments of the present invention. The YIG filter tuning system 10 includes a YIG filter 12, a noise source 14 selectively coupled to the input 13 of the YIG filter 12, and a receiver 16 coupled to the output 15 of the YIG filter 12. Elements of the YIG filter tuning system 10 are typically present in test and measurement systems, or in communication systems that operate in the RF, microwave, or millimeter-wave frequencies. For the purpose of illustration, elements of the YIG filter tuning system 10 are shown included within a conventional spectrum analyzer 20, as shown in FIG. 2, and operation of the YIG filter tuning system 10 is described in the context of the spectrum analyzer 20.

The YIG filter 12 is included within the pre-selector 22 of the spectrum analyzer 20, and the receiver 16 is implemented within the mixer/LO section 25 and the IF filter/detector section 24 of the spectrum analyzer 20. The YIG filter 12 is typically a two port device that provides bandpass filtering of signals 11 that are applied to the input 13. In one example of the spectrum analyzer 20, the YIG filter 12 within the pre-selector 22 provides bandpass filtering for signals 11 in the frequency range of 3.5-27 GHz, which are provided to the input 13 of the YIG filter 12 and mixed with signals provided by a local oscillator LO.

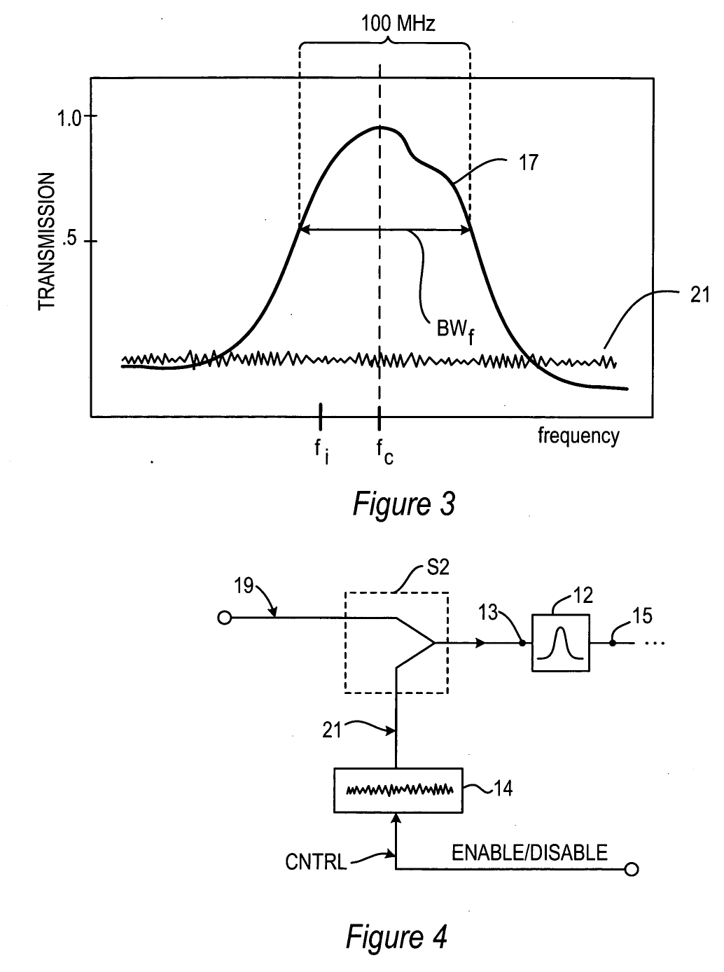

The YIG filter 12 has a filter passband 17 (shown in FIG. 3) with an associated filter bandwidth BWf. The filter bandwidth BWf of the YIG filter 12 typically varies with the center frequency fc to which the filter passband 17 is tuned. In the one example shown in FIG. 3, the YIG filter 12 has a filter bandwidth BWf, as designated by half-power points, that is approximately 100 MHz.

The center frequency fc of the filter passband 17 can be tuned over a wide frequency range in response to a drive current Id that is applied to one or more frequency control ports of the YIG filter 12. While the frequency range over which the filter passband 17 is tuned in the spectrum analyzer 20 extends from 3.5 GHz to 27 GHz, the filter passband 17 in alternative examples of the YIG filter 12 can be tuned over a frequency range that extends beyond or within the frequency range from 2 GHz to 30 GHz, or within any other suitable frequency range.

When the spectrum analyzer 20 acquires spectral measurements of an applied input signal 19, the YIG filter 12 is either set to one or more designated frequencies of interest fi by corresponding settings of the drive current Id, or the drive current Id is ramped or swept to achieve a swept-frequency spectral measurement of the applied input signal 19. When the drive current Id does not accurately set and maintain the center frequency fc of the filter passband 17 at the one or more designated measurement frequencies, amplitude errors result in the fixed-frequency spectral measurements performed by the spectrum analyzer 20. When the YIG filter 12 is misaligned during a swept-frequency spectral measurement of the applied input signal 19, amplitude errors result in the swept-frequency spectral measurement of the applied input signal 19.

In the examples of the YIG filter tuning system 10 provided in FIGS. 1-2, the YIG filter 12 is shown as a two port device that is separate from other elements within the YIG filter tuning system 10. In alternative examples, the YIG filter 12 is included within a system or subsystem wherein the YIG filter 12 is integrated with a YIG-tuned oscillator or a YIG multiplier, or integrated with other devices, elements or systems.

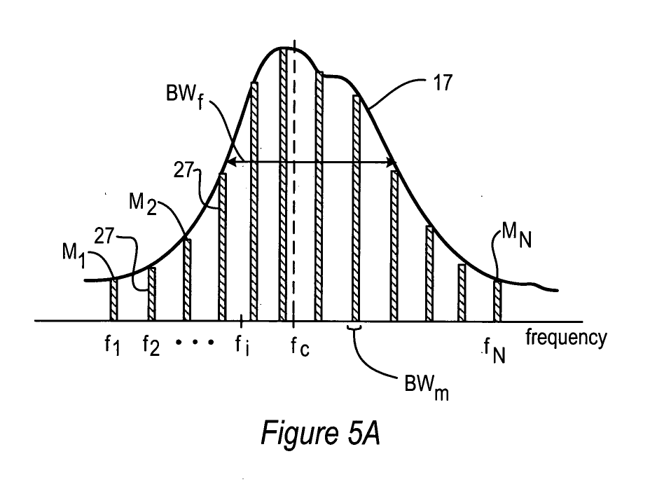

The noise source 14 included in the YIG filter tuning system 10 is selectively coupled to the input 13 of the YIG filter 12. In the example of the YIG filter tuning system 10 shown in FIG. 1, the selective coupling is provided by a switch SI interposed between the noise source 14 and the YIG filter 12. In another example (shown in FIG. 4), the selective coupling is provided with a signal combiner S2, with the noise source 14 enabled and disabled by a control signal CNTRL. In another example (shown in FIG. 2) the noise source 14 is implemented using a high-gain pre-amplifier A present within the input signal path of the pre-selector 22 of the spectrum analyzer 20. In this example, selective coupling of the noise source 14 to the YIG filter 12 is provided by providing bias to the pre-amplifier A without the applied input signal 19 applied to the input of the pre-amplifier A. In this example, the pre-amplifier A has a gain of 30 dB and provides a noise signal over a frequency range that extends from beyond 3.5 GHz to 27 GHz.

When coupled to the input 13 of the YIG filter 12, the noise source 14 provides a noise signal 21 to the YIG filter 12. According to one embodiment of the YIG filter tuning system 10, the noise signal 21 has a noise spectrum that is sufficiently broad to cover the frequency range over which the YIG filter 12 is tuned. Within the filter passband 17 of the YIG filter 12, the noise spectrum has a flat, or level, frequency profile, when compared to the frequency variations of the filter passband 17. In one example, the noise signal 21 resembles white noise when observed within the bandwidth of the filter passband 17. FIG. 3 shows one example of the noise spectrum of the noise signal 21 provided by the noise source 14, relative to the filter passband 17 of the YIG filter 12.

The noise source 14 that provides the noise signal 21 typically includes the pre-amplifier A or other amplifier available within the spectrum analyzer 20, or the noise source 14 includes a noise diode, or any other type of noise generator that can provide the noise spectrum. Alternatively, the noise source 24 includes a pseudo-random sequence generator or other type of digital signal source that provides the noise signal 21 with a broad-frequency, noise-like spectrum. Alternatively, the noise source 14 includes an impulse generator or other type of pulsed signal source that provides the noise signal 21 with a broad-frequency, noise-like spectrum.

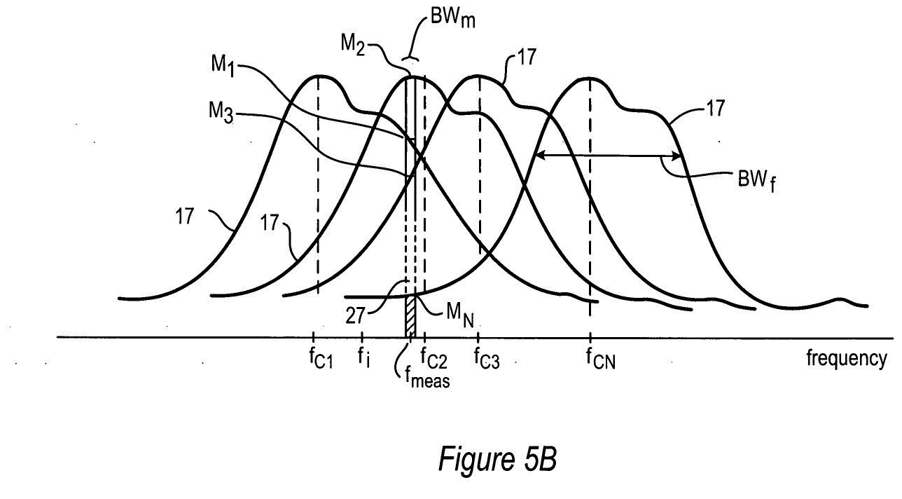

The receiver 16 included within the YIG filter tuning system 10 has a measurement passband 27 (shown in FIGS. 5A-5B) that has an associated measurement bandwidth BWm that is narrower than the filter bandwidth BWf of the YIG filter 12. In the spectrum analyzer 20, the measurement passband 27 of the receiver 16 is typically defined by an IF filter within the the IF filter/detector section 24 that establishes the resolution bandwidth of the spectrum analyzer 20.

The YIG filter tuning system 10 is suitable for providing frequency alignment of the center frequency fc of the filter passband 17 with one or more designated frequencies of interest fi, such as selected measurement frequencies of the spectrum analyzer 20. As a result of frequency alignment by the YIG filter tuning system 10, amplitude errors resulting from misalignment of the center frequency fc of the filter passband 17 are reduced.

Frequency alignment using the YIG filter tuning system 10 is typically invoked manually by a user of the spectrum analyzer 20, for example via user-entered keystrokes to the operating panel of the spectrum analyzer 20. Alternatively, frequency alignment using the YIG filter tuning system 10 is invoked automatically based on the operating state of the spectrum analyzer 20, transitions between operating states, or by other designated criteria. Typically, the frequency alignment is invoked and performed under the control of a processor 28, such as a computer, central processing unit (CPU), or other type of controller, included in the instrument or system within which the YIG filter tuning system 10 is included.

In providing frequency alignment of the center frequency fc of the filter passband 17 with one or more designated frequencies of interest fi, the receiver 16 acquires a series of measurements {M₁ . . . M_{N}} within the measurement passband 27 of the receiver 16. The series of measurements {M₁. . . M_{N}} are acquired at the output 15 of the YIG filter 12, with the noise source 14 coupled to the input 13 of the YIG filter 12. The series of measurements {M₁ . . . M_{N}} typically includes measurements of noise power within the measurement bandwidth BWm of the receiver 16, acquired with the measurement passband 27 positioned within the filter passband 17 of the YIG filter 12. In one example, the filter passband 17 within which the series of measurements {M₁ . . . M_{N}} is acquired extends two and one-half times the frequency width of the filter bandwidth BWf of the filter passband 17 defined by the half-power points of the filter passband 17. In alternative examples, the series of measurements {M₁ . . . M_{N}} is acquired over other sufficiently wide frequency ranges of the filter passband 17 to accommodate for the misalignments of the center frequency fc of the filter passband 17 with a frequency of interest fi.

In one example (shown in FIG. 5A) the series of measurements {M₁ . . . M_{N}} is acquired with the drive current Id provided to the YIG filter 12 set to a designated value, which sets the center frequency fc of the filter passband 17 to a predesignated center frequency fc. Due to misalignment in the frequency tuning of the filter passband 17, the center frequency fc is typically offset from the frequency of interest fi. Each of the measurements in the series of measurements {M₁ . . . M_{N}} is then acquired with the measurement passband 27 of the receiver 16 adjusted to a corresponding frequency within a series of measurement frequencies {f₁ . . . f_{N}}. In this example, each measurement in the series of measurements {M₁ . . . M_{N}} is a function of a corresponding frequency within a series of different frequencies {f₁ . . . f_{N}} to which the receiver 16 is tuned.

In an alternative example (shown in FIG. 5B) the measurement passband 27 of the receiver 16 is adjusted to a predesignated measurement frequency fmeas. Each of the measurements in the series of measurements {M₁ . . . M_{N}} is then acquired with the center frequency of the filter passband 17 of the YIG filter 12 adjusted to a corresponding frequency within a series of filter center frequencies {f_{C1} . . . f_{CN}}. In this example, each measurement in the series of measurements {M₁ . . . M_{N}} is a function of a corresponding center frequency within a series of different center frequencies {f_{C1} . . . f_{CN}} to which the filter passband 17 is tuned.

According to alternative embodiments of the YIG filter tuning system 10, the acquired series of measurements {M₁ . . . M_{N}} is processed in alternative ways to establish the error or misalignment of the center frequency fc of the filter passband 17 relative to the designated frequency of interest fi. Typically, the center frequency fc is aligned with the frequency of interest fi by determining the drive current Id that corresponds to the tuning position of the filter passband 17 that results with the center frequency fc of the filter passband 17 being aligned with the frequency of interest fi.

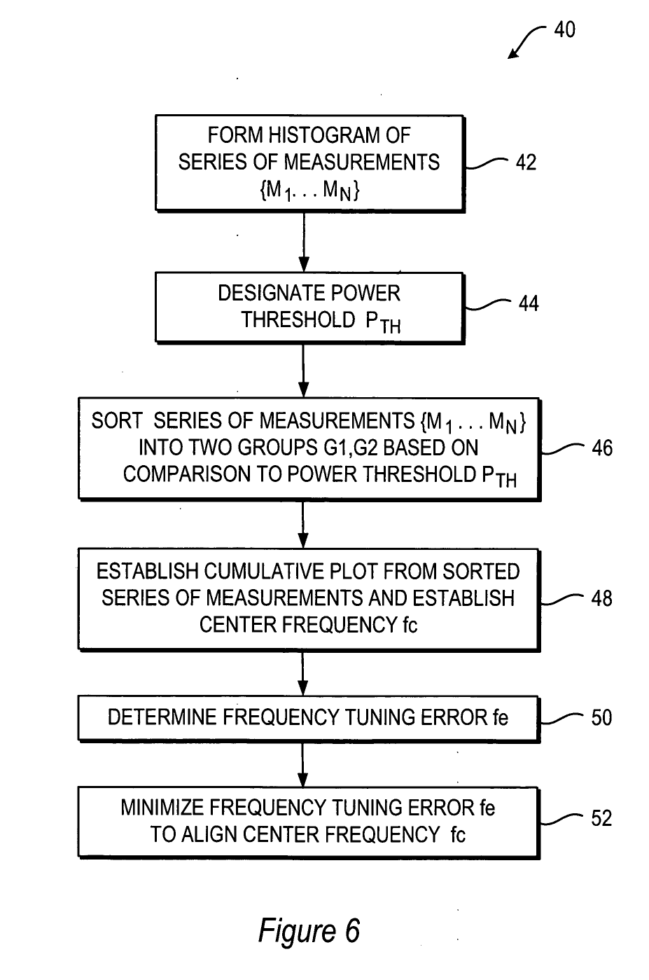

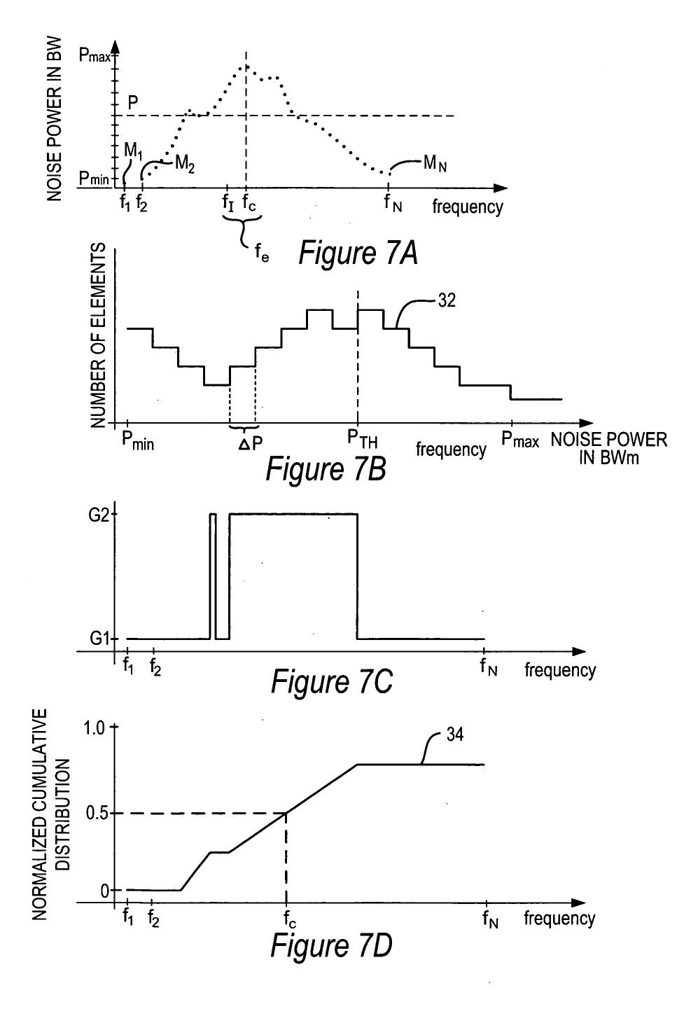

FIG. 6 shows a flow diagram 40 of one example processing of the series of measurements {M₁ . . . M_{N}} to provide for frequency alignment of the center frequency fc of the filter passband 17 with the frequency of interest fi. In this example, the series of measurements {M₁ . . . M_{N}} includes a series of noise power measurements that are acquired over a frequency range of the filter passband 17 that is two and a half times as wide as the filter bandwidth BWf. The noise power measurements are acquired within the measurement bandwidth BWm of the receiver 16, with the measurement passband 27 of the receiver 16 set to a corresponding series of measurement frequencies {f₁ . . . f_{N}} as shown in FIG. 5A and FIG. 7A.

Step 42 of the flow diagram 40 includes forming a histogram 32 of the series of measurements {M₁ . . . M_{N}}. In this example, the histogram 32 is established by sorting the measurements in the series of measurements {M₁ . . . M_{N}} into ranges of noise powers ΔP, within a noise power range that extends between the minimum noise power measurement Pmin and a maximum noise power measurement Pmax in the series of measurements {M₁ . . . M_{N}}, FIG. 7B shows an example histogram 32 of the series of measurements {M₁ . . . M_{N}}.

Step 44 includes designating a power threshold P_{TH} that is exceeded by a designated percentage of the elements of the histogram 32. FIGS. 7A, 7B show an example wherein the power threshold P_{TH} is exceeded by forty percent of the number of elements in the histogram 32.

In step 46, the measurements within the series of measurements {M₁ . . . M_{N}} are sorted into two groups G1, G2 based on a comparison of the measurements to the power threshold P_{TH}. One group G1 includes measurements in the series of measurements {M₁ . . . M_{N}} that are above the power threshold P_{TH}, and the other group G2 includes measurements in the series of measurements {M₁ . . . M_{N}} that are below the power threshold P_{TH}. The series of measurements that are sorted into the two groups G1, G2, as shown in FIG. 7C, are ordered according to the corresponding frequencies {f₁ . . . f_{N}} at which the series of measurements {M₁ . . . M_{N}} are acquired.

The sorted series of measurements shown in FIG. 7C is then integrated to establish a cumulative plot 34 in step 48, as shown in FIG. 7D. The center frequency fc of the filter passband 17 is then established from the cumulative plot 34, in this example, as the frequency corresponding to the half-amplitude point of the cumulative plot 34.

In step 50, a frequency tuning error fe associated with the filter passband 17 is determined as the difference between the center frequency fc and the frequency of interest fi. The frequency tuning error fe is minimized in step 52 by adjusting the drive current Id to the YIG filter 12, which results in the center frequency fc being aligned with the frequency of interest fi.

While the embodiments of the present invention have been illustrated in detail, it should be apparent that modifications and adaptations to these embodiments may occur to one skilled in the art without departing from the scope of the present invention as set forth in the following claims.

1. A YIG filter tuning system, comprising:
a YIG filter having a filter passband with an associated filter bandwidth;
a noise source selectively coupled to an input of the YIG filter; and
a receiver coupled to an output of the YIG filter, the receiver having a measurement passband with an associated measurement bandwidth that is less than the filter bandwidth, wherein the receiver acquires a series of measurements at the output of the YIG filter within the measurement passband and within the filter passband when the noise source is coupled to the input of the YIG filter.

2. The system of claim 1 wherein each of the acquired measurements in the series of measurements is acquired with the measurement passband adjusted to a corresponding frequency within a series of frequencies.

3. The system of claim 2 wherein the filter passband is adjusted to a predesignated frequency while the receiver acquires the series of measurements with the measurement passband adjusted to a corresponding frequency within a series of frequencies.

4. The system of claim 1 wherein each of the acquired measurements in the series of measurements is acquired with the filter passband adjusted to a corresponding frequency within a series of frequencies.

5. The system of claim 4 wherein the measurement passband is adjusted to a predesignated frequency while the receiver acquires the series of measurements with the filter passband adjusted to a corresponding frequency within a series of frequencies.

6. The system of claim 1 wherein the acquired series of measurements is processed to align a center frequency of the filter passband with a designated frequency of interest.

7. The system of claim 1 wherein the noise source includes an amplifier within an input signal path of a spectrum analyzer.

8. The system of claim 1 wherein the noise source provides a flat noise spectrum to the input of the YIG filter within the filter passband while the series of measurements is acquired by the receiver.

9. The system of claim 2 wherein the series of noise measurements includes a series of measurements of noise power within the measurement bandwidth, acquired at the corresponding frequencies within a series of frequencies.

10. The system of claim 1 wherein the YIG filter, the noise source, and the receiver are included within a spectrum analyzer.

11. A YIG filter tuning system, comprising:
setting a center frequency of a YIG filter, having a filter passband and an associated filter bandwidth, to a first frequency;
providing a noise signal to an input of the YIG filter;
acquiring a series of measurements within a measurement passband, having an associated measurement bandwidth that is less than the filter bandwidth, at the output of the YIG filter in response to the provided noise signal; and
processing the acquired series of measurements to align the center frequency of the YIG filter with a second frequency that is offset from the first frequency.

12. The system of claim 11 wherein each of the measurements in the series of measurements is acquired with the measurement passband adjusted to a corresponding frequency within a series of frequencies.

13. The system of claim 12 wherein the filter passband is adjusted to a predesignated frequency while the series of measurements is acquired with the measurement passband adjusted to a corresponding frequency within a series of frequencies.

14. The system of claim 11 wherein each of the acquired measurements in the series of measurements is acquired with the filter passband adjusted to a corresponding frequency within a series of frequencies.

15. The system of claim 14 wherein the measurement passband is adjusted to a predesignated frequency while the series of measurements is acquired with the filter passband adjusted to a corresponding frequency within a series of frequencies.

16. The system of claim 11 wherein processing the acquired series of measurements includes forming a histogram of the series of measurements, designating a power threshold for the series of measurements, sorting the series of measurements based on a comparison of the series of measurements to the power threshold, establishing a cumulative plot from the sorted series of measurements, and determining a frequency error based on the frequency difference between the first frequency and the second frequency.

17. The system of claim 11 wherein the noise signal is provided by an amplifier within an input signal path of a spectrum analyzer.

18. The system of claim 17 wherein the amplifier provides a flat noise spectrum to the input of the YIG filter within the filter passband while the series of measurements is acquired.

19. The system of claim 12 wherein the series of noise measurements includes a series of measurements of noise power within the measurement bandwidth, acquired at the corresponding frequencies within a series of frequencies.

20. The system of claim 11 wherein setting the center frequency of the YIG filter, providing the noise signal, acquiring the series of measurements, and processing the measured series of signals are provided within a spectrum analyzer.
